(19) United States
(12) Patent Application Publication
(10) Pub. No.: US 2026/0368275 A1
(43) Pub. Date: Nov. 19, 2026

(54) TRANSFORMING A NATURAL LANGUAGE DESCRIPTION OF AN OPTIMIZATION PROBLEM INTO AN OPTIMIZATION MODEL TO SOLVE

(71) Applicant: International Business Machines Corporation, Armonk, NY (US)

(72) Inventors: Dzung Tien Phan, PLEASANTVILLE, NY (US); Vinicius Lima Silva, New York, NY (US); Dhavalkumar C. Patel, White Plains, NY (US); Ali Koc, WHITE PLAINS, NY (US); Nianjun Zhou, Chappaqua, NY (US); Pavan Kapanipathi Bangalore, White Plains, NY (US); Luis A. Lastras-Montano, Cortlandt Manor, NY (US); Jayant R. Kalagnanam, Briarcliff Manor, NY (US)

(21) Appl. No.: 19/210,461

(22) Filed: May 16, 2025

(51) Int. Cl. G06F 17/18; G06F 40/279; G06F 40/58

(52) U.S. Cl. CPC G06F 17/18; G06F 40/279; G06F 40/58

(57) ABSTRACT

Provided are a computer implemented method, system, and computer program product for transforming a natural language description of an optimization problem into an optimization model to solve. A natural language description of an optimization problem is processed to generate extracted components comprising decision variables and constraints of the optimization problem. The extracted components of the decision variables and the constraints are processed to generate a mathematical formulation of the decision variables and the constraints. The mathematical formulation is processed to generate optimization models implementing the mathematical formulation in different optimization modelling languages. An optimization solver processes the optimization models to generate optimal solutions to the optimization problem. A determination is made of an optimal solution to the optimization problem from the optimal solutions.

### BACKGROUND OF THE INVENTION

The present invention relates to a computer implemented method, system, and computer program product for transforming a natural language description of an optimization problem into an optimization model to solve.

To solve an optimization problem, a large language model (LLM) may be used to process a natural language description of an optimization problem to generate an optimal solution of the problem. Another technique involves the use of the LLM to process the natural language description to generate an optimization model expressed in an optimization modelling language. The optimization model may then be processed by an optimization solver to generate an optimal solution.

### SUMMARY

Provided are a computer implemented method, system, and computer program product for transforming a natural language description of an optimization problem into an optimization model to solve. A natural language description of an optimization problem is processed to generate extracted components comprising decision variables and constraints of the optimization problem. The extracted components of the decision variables and the constraints are processed to generate a mathematical formulation of the decision variables and the constraints. The mathematical formulation is processed to generate optimization models implementing the mathematical formulation in different optimization modelling languages. An optimization solver processes the optimization models to generate optimal solutions to the optimization problem. A determination is made of an optimal solution to the optimization problem from the optimal solutions.

### BRIEF DESCRIPTION OF THE DRAWINGS

FIG. 1 illustrates a computing environment to solve optimization problems.

FIGS. 2A and 2B illustrate an embodiment of operations to solve an optimization problem expressed in a natural language description.

FIG. 3 illustrates a computing environment to generate training sets to train a generative artificial intelligence (AI) model to solve optimization problems.

FIG. 4 illustrates an embodiment of an extracted components training set.

FIG. 5 illustrates an embodiment of a mathematical formulation training set.

FIG. 6 illustrates an embodiment of an optimization model training set.

FIG. 7 illustrates an embodiment of operations to generate training sets to train a generative AI model to solve optimization problems.

FIG. 8 illustrates an embodiment of operations to train the generative AI Model

FIG. 9 illustrates an example of the natural language description of the optimization problem, the extracted components, the mathematical formulation, and the optimization model produced by the generative AI model.

FIG. 10 depicts a computing environment in which the components of FIGS. 1 and 3 may be implemented.

### DETAILED DESCRIPTION

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The description herein provides examples of embodiments of the invention, and variations and substitutions may be made in other embodiments. Several examples will now be provided to further clarify various embodiments of the present disclosure:

Example 1: A computer implemented method to optimize an optimization problem. The method comprises processing a natural language description of an optimization problem to generate extracted components comprising decision variables and constraints of the optimization problem. The method further comprises processing the extracted components of the decision variables and the constraints to generate a mathematical formulation of the decision variables and the constraints. The method further comprises processing the mathematical formulation to generate optimization models implementing the mathematical formulation in different optimization modelling languages. The method further comprises an optimization solver processing the optimization models to generate optimal solutions to the optimization problem. An optimal solution to the optimization problem is determined from the optimal solutions. Thus, embodiments advantageously allow for a series of determinations of components and intermediary solutions of a solution to an optimization problem, including extracted components, a mathematical formulation, and optimization models. Each determination builds on the previous determination to provide for multiple solutions to the optimization problem from multiple optimization models. In this way, an optimal solution can be determined from optimal solutions to the optimization problem produced from different optimization models to increase a likelihood of a correct optimal solution.

Example 2: The limitations of any of Examples 1 and 3-9, wherein the determining the optimal solution comprises determining whether a majority of the optimization models result in a same optimal solution. The optimal solution comprises the same optimal solution from the majority of optimization models. Thus, embodiments advantageously allow for the optimal solution to be selected from the majority of optimization models producing the same optimal solution to allow majority voting by the optimization models for the optimal solution. This increases the likelihood of an accurate optimal solution.

Example 3: The limitations of any of Examples 1, 2 and 4-9, wherein the processing the mathematical formulation to generate the optimization models comprises processing the natural language description of the optimization problem and the mathematical formulation to generate the optimization models in different optimization modelling languages. Thus, embodiments advantageously allow for the optimization models to be generated in different optimization modelling languages to allow for variance in the ways the optimization problem is solved to ensure independent verification from different optimization modelling techniques of the optimal solution.

Example 4: The limitations of any of Examples 1-3 and 5-9, wherein the method further comprises sending a first prompt requesting a generative artificial intelligence (AI) model to generate the extracted components from the natural language description of the optimization problem. The method further comprises sending a second prompt requesting the generative AI model to generate the mathematical formulation from the extracted components. The method further comprises sending a third prompt requesting the generative AI model to generate the optimization models in the different optimization modelling languages. Thus, embodiments advantageously allow for the use of a generative AI model to generate the extracted components, the mathematical formulation, and optimization models through the use of prompts to the generative AI model requesting the different generated components of the optimization process.

Example 5: The limitations of any of Examples 1~4 and 6-9, wherein the method further comprises processing the natural language description to determine assumptions and hypotheses defined in the natural language description. The method further comprises determining whether the constraints in the extracted components satisfy the assumptions and hypotheses. The extracted components are processed to generate the mathematical formulation in response to determining that the constraints in the extracted components satisfy the assumptions and hypotheses. Thus, embodiments advantageously allow for validation of the intermediate generated extracted components to increase the accuracy of the output of the mathematical formulation, which in turn improves the accuracy of the generated optimization models.

Example 6: The limitations of any of Examples 1-5 and 7-9, wherein the method further comprises processing the natural language description and the extracted components to determine assumptions and hypotheses based on the natural language description and the extracted components. The method further comprises determining whether conclusions from the mathematical formulation satisfy the assumptions and hypotheses, wherein the processing the mathematical formulation to generate the optimization models is performed in response to determining that the conclusions of the mathematical formulation satisfy the assumptions and hypotheses. Thus, embodiments advantageously allow for separate verification of the accuracy of the mathematical formulation by checking whether conclusions of the mathematical formulation satisfy hypotheses from the optimization problem to improve the accuracy of the mathematical formulation in expressing the optimization problem. This in turn improves the accuracy of the optimization models based on the mathematical formulation in expressing the optimization problem.

Example 7: The limitations of any of Examples 1-6, 8, and 9, wherein the method further comprises processing the natural language description and the extracted components to validate the extracted components as providing conclusions that satisfy the optimization problem. The processing the extracted components to generate the mathematical formulation is performed in response to validating the extracted components. The method further comprises processing the natural language description, the extracted components, and the mathematical formulation to validate the mathematical formulation as providing conclusions that satisfy the optimization problem. The processing the mathematical formulation to generate the optimization models is performed in response to determining that the conclusions of the mathematical formulation satisfy the optimization problem. Thus, embodiments advantageously allow for verification of the accuracy of the extracted components and the mathematical formulation before using the same to determine the mathematical formulation and the optimization models to improve the accuracy of the optimization models in expressing the optimization problem.

Example 8: The limitations of any of Examples 1-7 and 9, wherein a generative artificial intelligence (AI) model performs the processing the natural language description of the optimization problem to generate the extracted components, the processing the extracted components to generate the mathematical formulation, and the processing the mathematical formulation to generate the optimization models. Thus, embodiments advantageously use a generative AI model to generate the extracted components, mathematical formulation, and optimization models using verification to verify the accuracy of the inputs in each step to improve the accuracy of the optimization models used to generate the optimal solutions.

Example 9: The limitations of any of Examples 1-8, wherein the method further comprises determining that the optimization solver when processing an optimization model generated an error indicating the optimization solver was unable to generate output for an optimal solution. The processing the optimization models to generate the optimal solutions is performed in response to no optimization model resulting in an error when processed by the optimization solver. The method further comprises forwarding the error to the generative AI model to regenerate an optimization model that when executed by the optimization solver results in output for an optimal solution. Thus, embodiments advantageously allow for regenerating an optimization model for a modelling language when solving the model results in an error to allow the process to continue with a regenerated optimization model not resulting in an error.

Example 10 is an apparatus comprising means to perform a method of any of the Examples 1-9.

Example 11 is a machine-readable storage including machine-readable instructions, when executed, to implement a method or realize an apparatus of any of the Examples 1-9.

Example 12: A system comprising one or more processors and one or more computer-readable storage media collectively storing program instructions which, when executed by the processor, are configured to cause the processor to perform a method according to any of Examples 1-9.

Example 13: A computer program product comprising one or more computer readable storage media, and program instructions collectively stored on the one or more computer readable storage media, the program instructions comprising instructions configured to cause one or more processors to perform a method according to any one of Examples 1-9.

Additionally or alternatively, an embodiment in which Example 1 validates the extracted components and mathematical formulation by performing both Examples 5 and 6. This alternative embodiment provides for validation of both of the intermediate determined components of the extracted components and mathematical formulation before proceeding to the next determination. This improves the confidence in the outputs at each stage to increase the likelihood the optimization models accurately models the initial optimization problem.

A large language model or data scientist translating a natural description language expressing an optimization problem into an optimization model in an optimization modelling language may fail to incorporate certain constraints and decision variables of the optimization problem. This may result in an optimization model that produces a solution that does not satisfy the constraints of the optimization problem.

Described embodiments provide improvements to computer technology for solving optimization problems using generative artificial intelligence (AI) models by performing a series of operations to produce intermediate representations of the optimization problem that are each independently validated before progressing to the next stage of generating the optimization model to solve the optimization problem.

Described embodiments use a generative AI model to produce extracted components, including decision variables, constraints, and objectives, of an optimization problem expressed in a natural language description. The extracted components and natural language description are further used to generate a mathematical formulation upon verifying the extracted components satisfy requirements of the optimization problem. Further, upon verifying that the mathematical formulation satisfies the constraints and requirements of the optimization problem, the generative AI model is used to generate optimization models in different optimization modelling languages.

To provide a high confidence the final determined optimal solution is correct, described embodiments determine an optimal solution produced from a majority of the optimization models in the different optimization modelling languages by invoking an optimization solver. This provides a verification from a majority of the optimization models that the produced optimal solution is correct.

Further embodiments provide improvements to computer technology for generating training sets to train the generative AI model. To generate a sufficiently large number of training sets without having predetermined ground truth outputs for optimization problems, described embodiments process subsets of seed optimization problems of a set of seed optimization problems to synthesize into a synthetic optimization problem in a synthetic natural language description. This synthetic optimization problem is then processed by a generative AI model to produce an optimal solution having sufficient confidence in being correct. Training sets may then be generated based on the synthetic natural language description and the outputted extracted components, mathematical formulations, optimization models, and optimal solutions. These generated training sets may then be used to train the generative AI model to process the input natural language description of the optimization problem to output extracted components, mathematical formulations, and optimization models to produce optimal solutions with a high level of confidence.

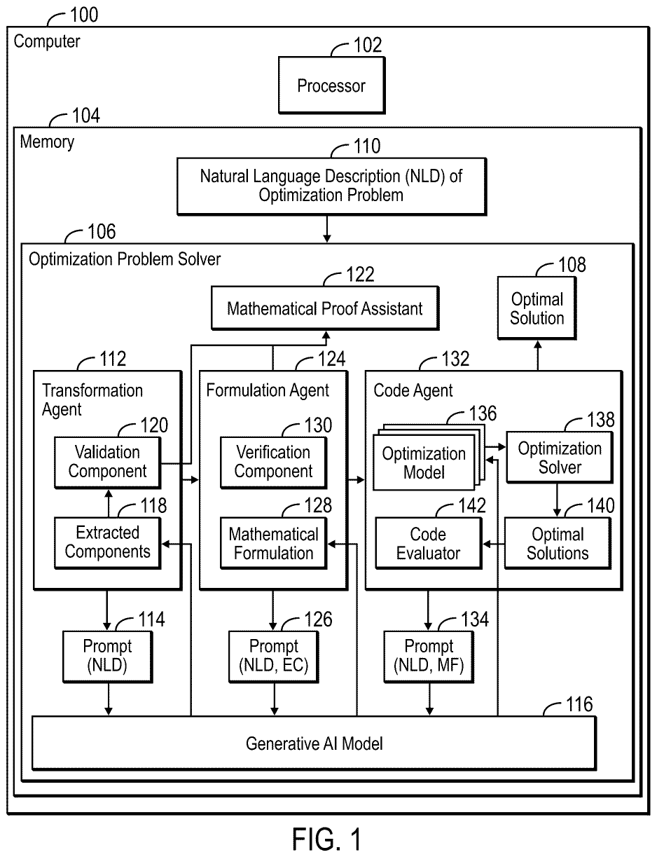

FIG. 1 illustrates an embodiment of a computer system 100 in which embodiments are implemented. The system 100 includes a processor 102 and a main memory 104. The main memory 104 includes an optimization problem solver 106 to generate an optimal solution 108 for an optimization problem defined in a natural language description (NLD) 110.

An optimization problem comprises a mathematical problem to find the best possible solution, either maximizing or minimizing a specific objective function, while satisfying certain constraints. These problems are used in various fields, including economics, business, engineering, and computer science. An optimization problem comprises an objective function, decision variables, and constraints. The objective function seeks to maximize or minimize a goal to achieve, such as maximizing profit, minimizing cost, or finding the shortest path. The decisions variables are variables to control or change to influence the outcome of the objective function, including parameters to adjust to find the best solution. The constraints comprise restrictions or limitations that must be met by the decision variables. These can be equations, inequalities, or other conditions that define the feasible region of solutions.

The optimization problem solver 106 includes a transformation agent 112 that generates a prompt 114 including the natural language description 110 of the optimization problem to query a generative AI model 116 to generate extracted components 118 from the natural language description 110. The extracted components 118 may comprise the decision variables, constraints, and objective of the optimization problem as defined in the natural language description 110. The generative AI model 116 may comprise a generative machine learning model or generative Artificial Intelligence (AI) model, also referred to as artificial intelligence, and include additional architectures such as transformers to model relationships in data and generate outputs based on input prompts. In certain embodiments, the generative AI model 116 may comprise a large language model (LLM).

The transformation agent 112 further includes a validation component 120 that calls a mathematical proof assistant 122 with the extracted components and natural language description to generate hypotheses and assumptions of the optimization problem. The mathematical proof assistant may determine whether conclusions defined in the extracted components satisfy the hypotheses and assumptions determined from the natural language description. The mathematical proof assistant may comprise Lean Hypothesis Testing tools.

Upon validating that the extracted components satisfy the hypothesis and assumptions in the natural language description, a formulation agent 124 may generate a prompt 126 including the natural language description and extracted components (ECs) to the generative AI model. In response, the generative AI model generates a mathematical formulation 128 providing a mathematical expression of the optimization problem expressed in a natural language description and the extracted components. A verification component 130 may call the mathematical proof assistant to verify that the mathematical formulation satisfies hypothesis and conclusions of the natural language description. For instance, the mathematical proof assistant may determine whether there are any missing decision variables and constraints in the generated extracted components and mathematical formulation. For instance, the mathematical proof assistant may determine whether an equation in the constraint sets satisfies hypothesis and conclusions of the natural language description.

If the mathematical formulation is verified, a code agent 132 is invoked to generate a prompt 134 with the natural language description (NLD) and mathematical formulation (MF) to input to the generative AI model. In response, the generative AI model outputs optimization models 136 expressing the mathematical formulation in different optimization modeling languages, such as Pyomo, Decision Optimization Modeling for Python (DOcplex)®, Advanced Modeling for Optimization Solutions (AMPL®), etc. The optimization models implement the optimization problem expressed by the mathematical formulation and can be invoked and executed by an optimization solver 138, such as CPLEX®. (DOcplex and CPLEX are registered trademarks of International Business Machines Corporation throughout the world; and AMPL is a registered trademark of AMPL Optimization, Inc.).

The optimization solver 138 processes the optimization models 136 to generate optimal solutions 140 to the optimization problem reflected in the optimization models 136. A code evaluator 142 determines whether a majority of optimal solutions are the same. If so, the code evaluator outputs the majority optimal solution as the optimal solution 108 to the optimization problem reflected in the initial natural language description.

The memory 104 may comprise suitable volatile or non-volatile memory devices known in the art. For instance, the memory 104 may comprise one or more memory devices volatile or non-volatile, such as a Dynamic Random Access Memory (DRAM), a phase change memory (PCM), Magnetoresistive random-access memory (MRAM), Spin Transfer Torque (STT)-MRAM, SRAM storage devices, DRAM, a ferroelectric random-access memory (Efram), nanowire-based non-volatile memory, and Direct In-Line Memory Modules (DIMMs), NAND storage, e.g., flash memory, Solid State Drive (SSD) storage, non-volatile RAM, etc.

Generally, program modules, such as the program components 106, 112, 116, 122, 124, 130, 132, 138, 140, 142 among others, may comprise routines, programs, objects, components, logic, data structures, and so on that perform particular tasks or implement particular abstract data types. The program components and hardware devices of the system 100 may be implemented in one or more computer systems, where if they are implemented in multiple computer systems, then the computer systems may communicate over a network.

The program components 106, 112, 116, 122, 124, 130, 132, 138, 140, 142, among others, may be accessed by the processor 102 from the memory 104 to execute. Alternatively, some or all of the program components 106, 112, 116, 122, 124, 130, 132, 138, 140, 142, may be implemented in separate hardware devices, such as Application Specific Integrated Circuit (ASIC), Field Programmable Gate Arrays (FPGAs) and other hardware devices.

The functions described as performed by the program components 106, 112, 116, 122, 124, 130, 132, 138, 140, 142, among others, may be implemented as program code in fewer program modules than shown or implemented as program code throughout a greater number of program modules than shown.

Certain of the components, such as the mathematical proof assistant 122, optimization solver 138, and generative AI model 116 may be implemented as generative machine learning models or generative AI, including large language models (LLMs). Alternatively, other types of machine learning algorithms may be used, such as deep learning algorithms and natural language processor (NLP) algorithms. Program components implementing machine learning models, e.g., 116, 122, 138, may be implemented in an Artificial Intelligence (AI) hardware accelerator, such as an FPGA or a graphics processing unit (GPU).

FIG. 1 shows generative AI model 116 prompted to generate extracted components, a mathematical formulation and optimization models in different optimization modeling languages. In further embodiments, the generative AI model may comprise multiple generative AI models, wherein each generative AI model is used specifically to generate one of extracted components, mathematical formulations, and optimization models. In this way, the generative AI model described herein may be comprised of a single generative model or multiple smaller generative AI models to generate the specific outputs for the optimization problem.

In certain embodiments, components, such as 116, 122, 138, implementing a machine learning model, may use machine learning and deep learning algorithms, such as decision tree learning, generative AI, neural network, inductive programming logic, support vector machines, Bayesian network, Recurrent Neural Networks (RNN), Feedforward Neural Networks, Convolutional Neural Networks (CNN), Deep Convolutional Neural Networks (DCNNs), Generative Adversarial Network (GAN), etc.

For artificial neural network program implementations, the generative AI models 116, 122, 138 maybe trained using as input the input to these components to produce desired output for the inputs. In certain embodiments, the generative AI models may be trained using backward propagation to adjust weights and biases at nodes in a hidden layer to produce their output based on the received inputs. In backward propagation, biases at nodes in the hidden layer are adjusted accordingly to produce the output, such as the prompt answers, from input comprising the prompts, with specified confidence levels based on the input parameters. Backward propagation may comprise an algorithm for supervised learning of artificial neural networks using gradient descent to minimize the errors in predictions. Given a large language model artificial neural network and an error function, the method may use gradient descent to find the parameters (coefficients) for the nodes in a neural network or function that minimizes a cost function measuring the difference or error between actual and predicted values for different parameters. The parameters are continually adjusted during gradient descent to minimize the error.

In further embodiments, techniques other than backward propagation may be used to train the generative AI models 116, 122, 138.

The arrows shown in FIG. 1 between the components in the memory 104 represent a data flow between the components.

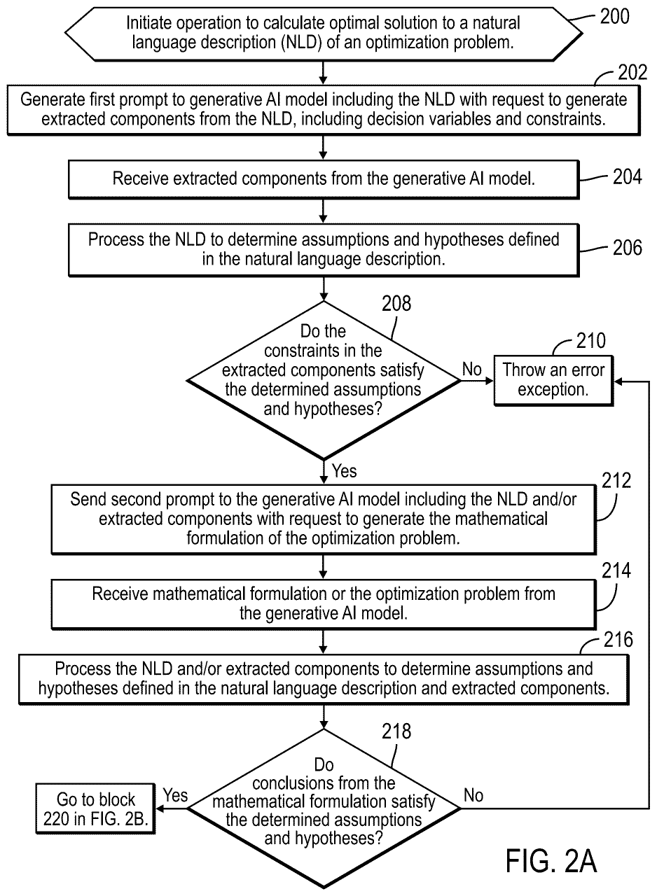

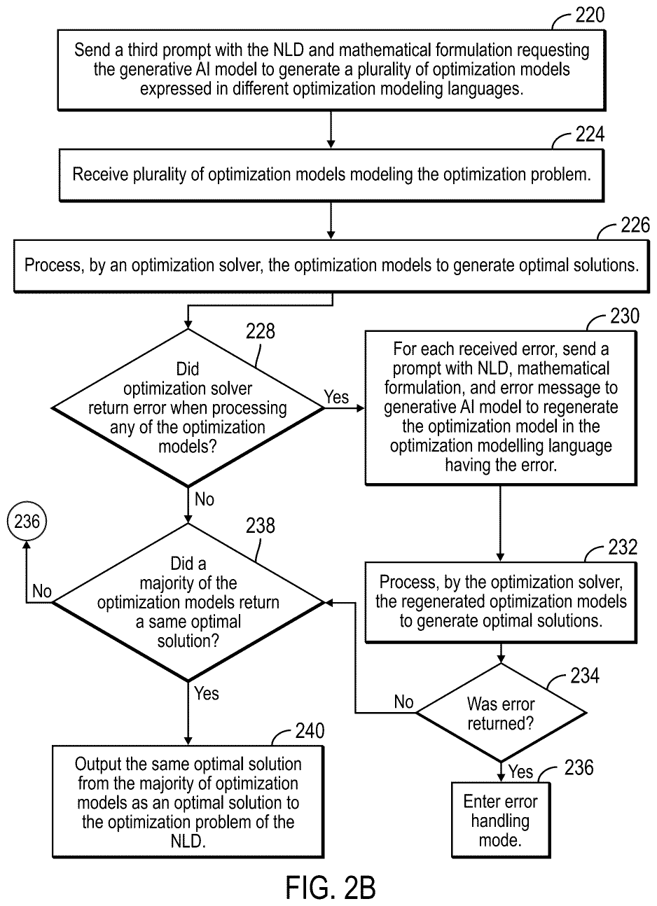

FIGS. 2A and 2B illustrate an embodiment of operations to process a natural language description of an optimization problem to generate an optimal solution utilizing a generative AI model. In certain embodiments, the components of the optimization problem solver 106 are used to perform the operations of FIGS. 2A and 2B. Upon initiating (at block 200) an operation to calculate an optimal solution to a natural language description (NLD) of an optimization problem, a component of the optimization problem solver, such as the transformation agent 112 or similar component, generates (at block 202) a prompt to the generative AI model including the natural language description with a request to generate extracted components from the NLD. The extracted components may include decision, variables, constraints, and objectives defined in the optimization problem of the natural language description. Upon receiving (at block 204) the extracted components from the generative AI model, a validation process may be initiated, such as by the validation component 120, to call a component, such as mathematical proof assistant 122 or similar component, to process (at block 206) the natural language description to determine assumptions and hypotheses defined in the natural language description.

A determination is made (at block 208) whether the constraints in the extracted components satisfy the determined assumptions and hypotheses from the natural language description, e.g., are any constraints missing. If (at block 208) the extracted components do not satisfy the determined assumptions and hypothesis, an error exception is thrown (at block 210). If (at block 208) the extracted components satisfy the determined assumptions and hypothesis, then a second prompt is sent (at block 212), such as by the formulation agent 124 or similar component, to the generative AI model. This second prompt may include the NLD and/or extracted components to input to the generative AI model to output a mathematical formulation of the optimization problem.

Upon receiving (at block 214) the mathematical formulation of the optimization problem from the generative AI model, a verification process may be initiated, such as by verification component 130, to process (at block 216) the natural language description and/or extracted components to determine assumptions and hypotheses defined in the natural language description and extracted components. If (at block 218) the conclusions from the mathematical formulation do not satisfy the determined assumptions and hypotheses, then an error exception is thrown (at block 210). Otherwise, if a conclusion of the mathematical formulation does satisfy determined assumptions and hypothesis, then control proceeds to block 220 in FIG. 2B.

The operations performed at blocks 206 and 216 to determine assumptions and hypotheses and the operations at blocks 208 and 218 to determine whether conclusions satisfy the determined assumptions and hypothesis may be performed by the mathematical proof assistant or other component(s).

Upon verifying the mathematical formulation, a third prompt is sent (at block 220), such as by the code agent 132 or similar component, to the generative AI model. This third prompt may include the natural language description and mathematical formulation to input to the generative AI model to output optimization models representing the mathematical formulation in different optimization modelling languages. Upon receiving (at block 224) a plurality of optimization models modeling the optimization problem, an optimization solver, such as optimization solver 138, may process (at block 226) the optimization models to generate optimal solutions from the models.

If (at block 228) the optimization solver returned an error for any of the processed optimization models, a prompt may be sent (at block 230), such as by the code agent 132 or similar component, to the generative AI model with the natural language description, mathematical formulation, and error message to request to regenerate the optimization model in the modeling language having the error. The optimization solver processes (at block 232) the regenerated optimization models to generate optimal solutions. If (at block 234) an error was returned when solving a regenerated optimization model, then an error handling mode is entered (at block 236).

If (at block 234) the optimization solver successfully generated an optimal solution for the regenerated optimization models or if (at block 228) the optimization solver did not return an error when processing the optimization models, then a determination is made (at block 238), such as by the code evaluator 142 or similar component, whether a majority of the optimization models returned a same optimal solution. If so, then that same optimal solution from the majority of the optimization models is outputted (at block 240) as an optimal solution to the optimization problem defined in the natural language description. If (at block 238) a majority of the optimization models did not return the same optimal solution, then an error handling mode is entered (at block 236).

With the embodiment of operations of FIGS. 2A and 2B, an architecture is provided to generate independently derived intermediate outputs for of an optimization problem, such as extracted components and a mathematical formulation, in order to independently verify and then use the intermediary components to input to a generative AI model to generate optimization models in different optimization modeling languages that express the optimization problem. This process allows for independent checking and verification of extracted components and a mathematical formulation of the optimization problem defined in the natural language definition. Further, by generating a plurality of optimization models to run through an optimization solver, an optimal solution may be determined that results from a majority of the optimization models to provide a solution with a high level of confidence.

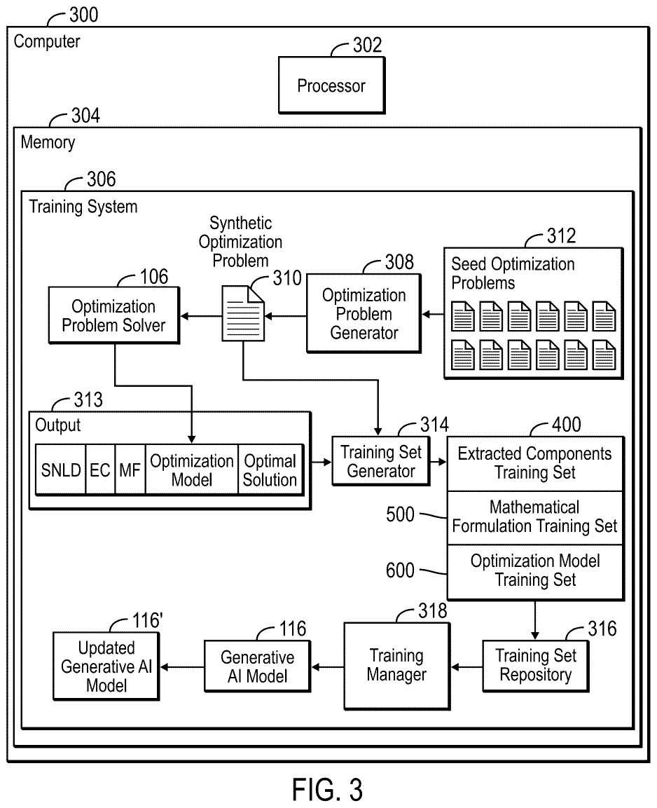

FIG. 3 illustrates an embodiment of a computer system 300 in which

embodiments are implemented. The system 300 includes a processor 302 and a main memory 304. The main memory 304 includes a training system 306 to generate training sets to train the generative AI model, such as generative AI model 116. The training system includes an optimization problem generator 308 to generate a large number of synthetic optimization problems 310 defined in a natural language description from a set of gathered seed optimization problems 312 defined in natural language descriptions. For instance, natural language descriptions of optimization problems may be gathered from various sources in different domains.

The optimization problem generator may randomly select different combinations of subsets of the full set of seed optimization problems to generate synthetic optimization problems 310 from multiple selected of the seed optimization problems 312. For instance, if there are n seed optimization problems, the optimization problem generator may select subsets of k of the n seed optimization problems. The number of possible formed subsets can be determined from the combinatorics formula “known k choose n”, or nCk, having the formula of

$$\frac{n !}{k ! \cdot ( n - k ) !}$$

number of subsets. For instance, if there are 145 gathered seed problems and subsets of 5 seed problems are randomly selected to synthesize into a synthetic optimization problem, then there would be about 500 million subsets resulting in 500 million synthetic optimization problems to use to form training sets to train the generative AI model.

The optimization problem generator may synthesize the subset of seed optimization problems into a single synthetic optimization problem. To synthesize the subset of seed optimization problems, which may be in different domains, the optimization problem generator may have to identify the objectives of the seed optimization problems, extract decision variables, define constraints, and formulate a unified objective function by integrating decision variables and constraints, which may require resolving conflicting objectives and constraints.

The synthetic optimization problem is inputted to an optimization problem solver, such as the optimization problem solver 106, to generate output 313 from the different agents, such as agents 120, 124, and 132 described above. The output 313 may include the synthetic natural language description (SNLD) of the synthetic optimization problem, generated extracted components (EC), e.g., 118, the generated mathematical formulation (MF), e.g., 128, optimization models in different modelling languages, e.g., 136, and the majority optimal solution 108. The outputted optimal solution may comprise the majority voted optimal solution produced by a majority of the optimization models. A training set generator 314 may generate from the output 313 training sets to train the generative AI model to produce the different outputs, including extracted components, mathematical formulation, and the optimization models for different modelling languages. The generated training sets may include an extracted component training set 400, a mathematical formulation training set 500, and an optimization model training set 600.

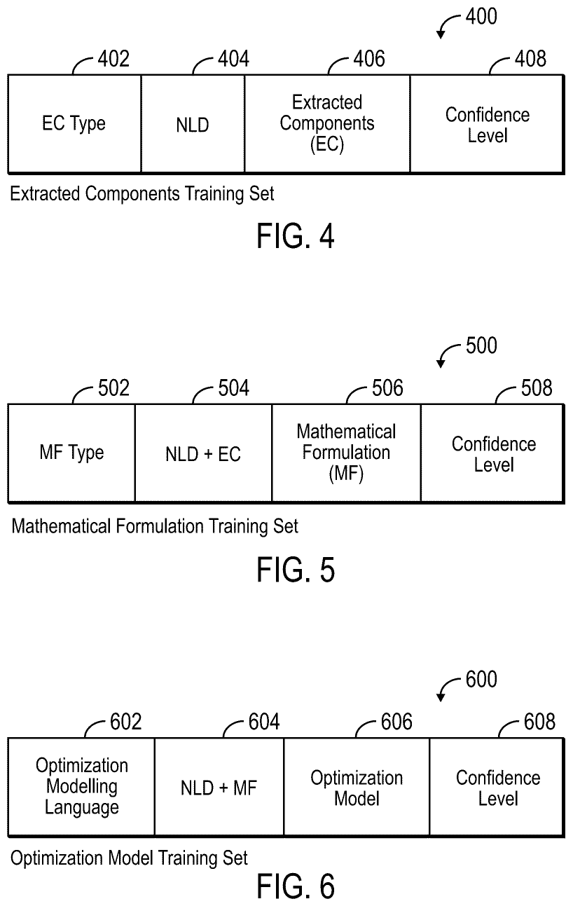

A shown in FIG. 4, the extracted components training set 400 may include, without limitation, a type field 402 indicating extracted components (EC) type, the natural language description 404 inputted to the generative AI model to produce the extracted components 406, and a confidence level 408 produced by the generative AI model indicating a likelihood the output extracted components are correct.

A shown in FIG. 5, the mathematical formulation training set 500 may include, without limitation, a type field 502 indicating a mathematical formulation (MF) type, the natural language description (NLD) and extracted components (EC) 504 inputted to the generative AI model to produce the mathematical formulation 506, and a confidence level 508 produced by the generative AI model indicating a likelihood the output mathematical formulation is correct.

A shown in FIG. 6, a optimization model training set 600 may include, without limitation, an optimization modelling language field 602 indicating the optimization modelling language of the generated optimization model, the natural language description (NLD) and mathematical formulation (MF) 604 inputted to the generative AI model to produce the optimization model 606 in the optimization modelling language 602, and a confidence level 608 produced by the generative AI model indicating a likelihood the output optimization model is correct, or correctly represents the synthetic optimization problem in the optimization modelling language.

The training sets 400, 500, 600 generated for the synthetic optimization problem may be stored in a training set repository 316. A training manager 318 may access the training sets to use backpropagation or other training techniques described above to train the generative AI model 116 to produce the different outputs of extracted components, mathematical formulations, and optimization models to produce an updated generative AI model 116′. This updated generative AI model 116′ may then be deployed at client systems or a cloud based inference engine to use to solve optimization problems described in natural language descriptions.

The memory 304 may comprise a similar memory to the memory 104 described above.

Generally, program modules, such as the program components 308, 314, and 318, among others, may comprise routines, programs, objects, components, logic, data structures, and so on that perform particular tasks or implement particular abstract data types. The program components and hardware devices of the system 300 may be implemented in one or more computer systems, where if they are implemented in multiple computer systems, then the computer systems may communicate over a network.

The program components 308, 314, and 318, among others, may be accessed by the processor 302 from the memory 304 to execute. Alternatively, some or all of the program components 308, 314, and 318, may be implemented in separate hardware devices, such as Application Specific Integrated Circuit (ASIC), Field Programmable Gate Arrays (FPGAs) and other hardware devices.

The functions described as performed by the program components 308, 314, and 318, among others, may be implemented as program code in fewer program modules than shown or implemented as program code throughout a greater number of program modules than shown.

Certain of the components, such as the optimization problem generator 308, may be implemented as generative machine learning models or generative AI, including large language models (LLMs). Alternatively, other types of machine learning algorithms may be used, such as deep learning algorithms and natural language processor (NLP) algorithms. Program components implementing machine learning models, e.g., 308, may be implemented in an Artificial Intelligence (AI) hardware accelerator, such as an FPGA or a graphics processing unit (GPU).

The optimization problem generator 308 may be implemented as a machine learning model as described above with respect to components 116, 122, 138.

The training manager 318 may train the generative AI model 116 as described above using backward propagation and other training techniques.

The arrows shown in FIG. 3 between the components in the memory 104 represent a data flow between the components.

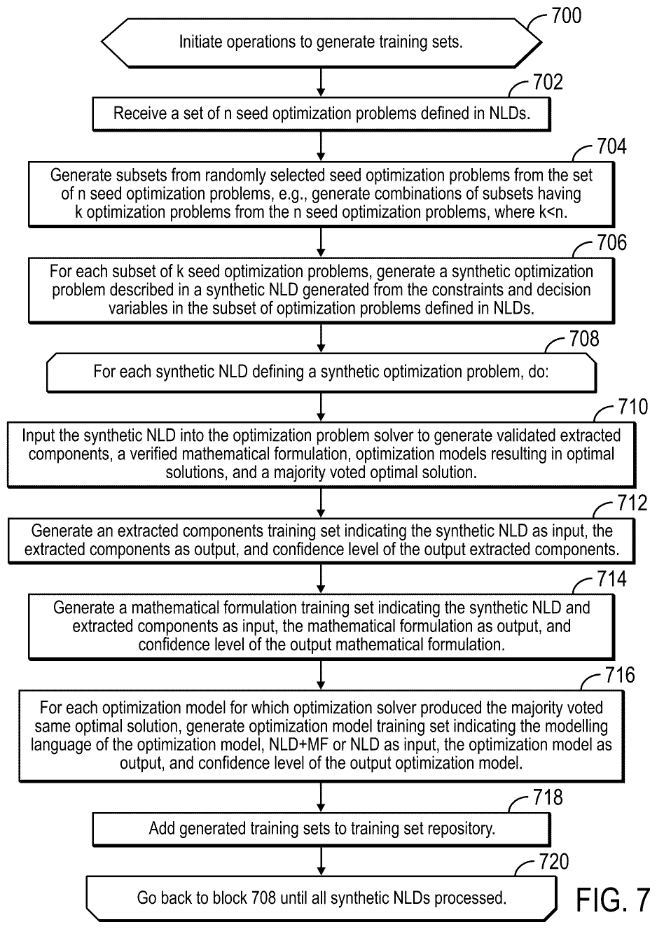

FIG. 7 illustrates an embodiment of operations performed to generate training sets to train the generative AI model to produce extracted components, mathematical formulations, and optimization models. In certain embodiments, the components of the training system 306 are used to perform the operations of FIG. 7. Upon initiating (at block 700) operations to generate training sets to train the generative AI model, an optimization problem generator, e.g., 308, receives (at block 702) seed optimization problems, e.g., 312, which may be in different domains. The optimization problem generator generates (at block 704) subsets of k randomly selected seed optimization problems from the set of n seed optimization problems. For instance, the optimization problem generator may generate combinations of subsets having k randomly selected optimization problems from the n seed optimization problems, where k<n. For each subset of k seed optimization problems, the optimization problem generator may generate (at block 706) a synthetic optimization problem described in a synthetic natural language description generated from the constraints and decision variables in the subset of optimization problems defined in natural language descriptions.

A loop of operations is performed at blocks 708 through 720 for each synthetic natural language description defining a synthetic optimization problem. At block 710, the synthetic natural language description is inputted into the optimization problem solver, e.g., 106, to generate validated extracted components, a verified mathematical formulation, optimization models resulting in optimal solutions, and a majority voted optimal solution. The training set generator, e.g., 314, generates (at block 712) extracted components training set, e.g., 400, indicating the synthetic natural language description as input, the extracted components as output, and a confidence level of the output extracted components. The training set generator generates (at block 714) a mathematical formulation training set, e.g., 500, indicating the synthetic natural language description and extracted components as inputs, the mathematical formulation as output, and a confidence level of the output mathematical formulation.

For each optimization model for which the optimization solver produced the majority voted optimal solution, the training set generator generates (at block 716) an optimization model training set, e.g., 600, indicating the optimization modelling language of the optimization model, the natural language description and mathematical formulation or just natural language description as inputs, the optimization model as output, and the confidence level of the optimization model output. Certain optimization modelling instances may only require the natural language description to generate the optimization model and others may require as input the mathematical formulation and the natural language description. The generated extracted components, mathematical formulation, and optimization models training sets are added (at block 718) to a training set repository to later use to train the generative AI model.

Described embodiments provide techniques to generate vast numbers of training sets, including training sets for different outputs to be produced by the generative AI model. In this way, numerous training sets may be generated without having ground truth values because the generated extracted components, mathematical formulations, and optimization models are verified during the process, to provide a degree of confidence in the outputs to use as the ground truth values.

In further embodiments, if the seed optimization problems include ground truth optimal solutions, then extracted component, mathematical formulation, and optimization model training sets may be generated from the seed optimization problems and their known optimal solutions to use to further supplement the training sets in the repository.

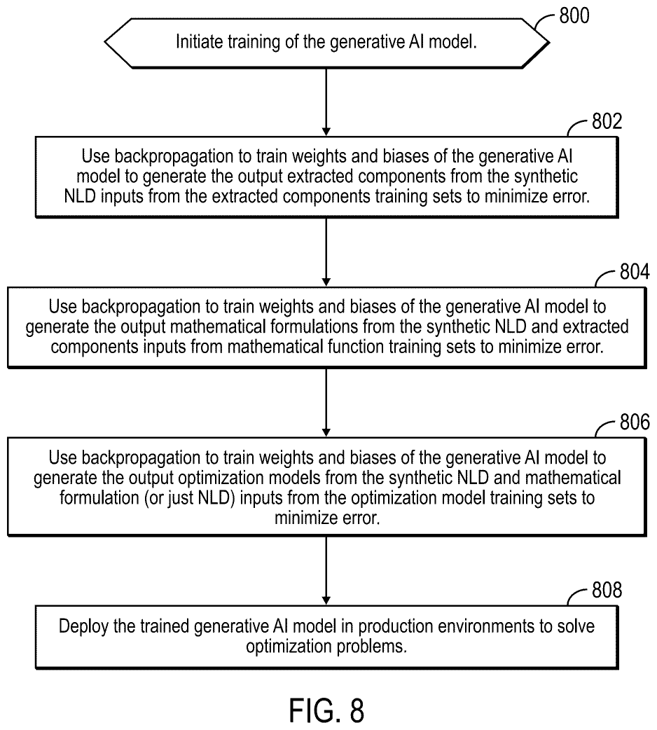

FIG. 8 illustrates an embodiment of operations performed to train the generative AI model with the training sets in the repository generated from the synthetic optimization problems. In certain embodiments, the training manager 318 is used to perform the operations of FIG. 8. Upon initiating (at block 800) training of the generative AI model, e.g., 116, the training manager uses (at block 802) backpropagation to train weights and biases of the generative AI model to generate the output extracted components from the synthetic NLD inputs in extracted components training sets, e.g., 400, in the repository to minimize error in a cost function. The error is minimized between the output extracted components the generative AI model produces from the inputs in the training sets and the output extracted components indicated in the extracted components training sets.

The training manager uses (at block 804) backpropagation to train weights and biases of the generative AI model to generate the output mathematical formulations from the synthetic NLD and extracted components inputs in mathematical formulation training sets, e.g., 500, in the repository to minimize error in a cost function. The error is minimized between the output mathematical formulations the generative AI model produces from the inputs in the mathematical formulation training sets and the output mathematical formulations indicated in the mathematical formulation training sets. The training manager uses (at block 806) backpropagation to train weights and biases of the generative AI model to generate the output optimization models from the synthetic NLD and mathematical formulation inputs in optimization model training sets, e.g., 600, in the repository to minimize error in a cost function. The error is minimized between the output optimization models the generative AI model produces from the inputs in the optimization model training sets and the output optimization models indicated in the optimization model training sets.

The trained generative AI model may then be deployed (at block 808) in production environments or cloud based inference engines to solve optimization problems.

With the described embodiment of FIG. 8, the generative AI model is trained with the different types of training sets to produce the different types of output information, e.g., extracted components, mathematical formulations, and optimization models, used to solve the optimization problem reflected in a natural language description.

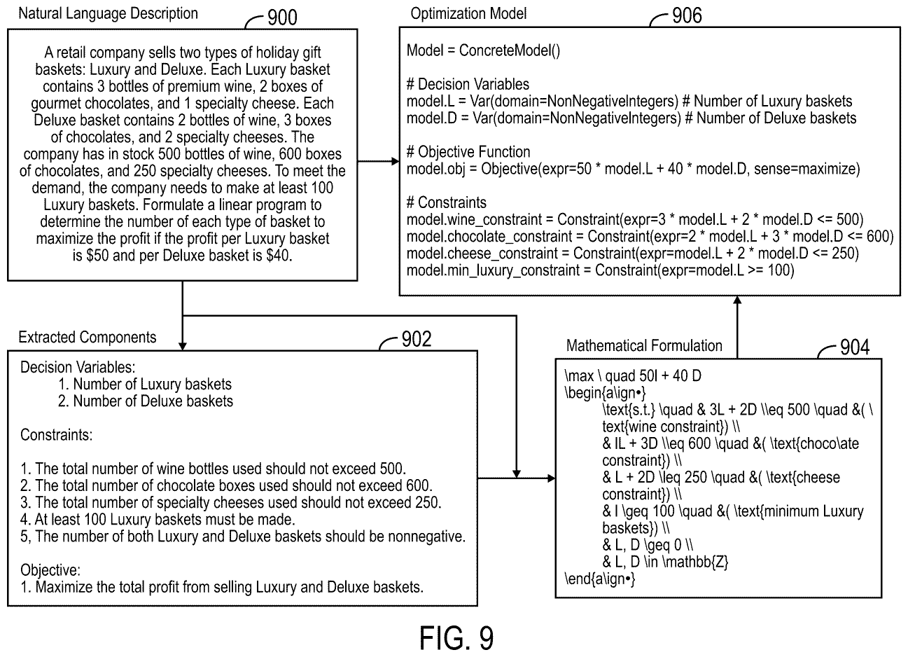

FIG. 9 illustrates an example of a natural language description 900 expressing an optimization problem that is transformed by the generative AI model to extracted components 902. The generative AI model may process the natural language description 900 and extracted components 902 to generate a mathematical formulation 904. The generative AI model further processes the mathematical formulation 904 and natural language description 900 to generate the optimization model, which may be in an optimization modelling language such as Pyomo.

The present invention may be a system, a method, and/or a computer program product. The computer program product may include a computer readable storage medium (or media) having computer readable program instructions thereon for causing a processor to carry out aspects of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

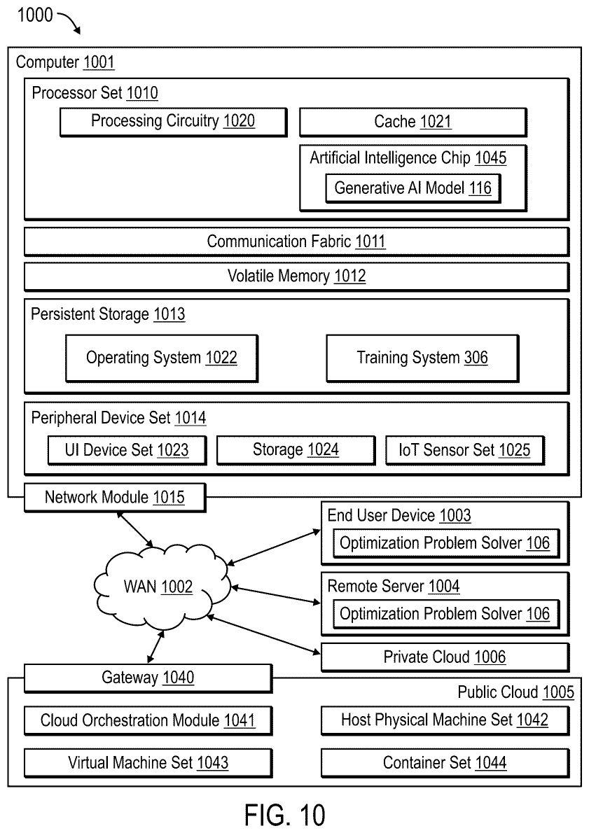

With respect to FIG. 10, computing environment 1000 contains an example of an environment for the execution of at least some of the computer code involved in implementing the optimization problem solver, e.g., 106, and training system, e.g., 306, to train the generative AI model, e.g., 116, to generate output to solve optimization problems described above. The computing environment 1000 may further include, for example, computer 1001, wide area network (WAN) 1002, end user device (EUD) 1003, remote server 1004, public cloud 1005, and private cloud 1006. In this embodiment, computer 1001 includes processor set 1010 (including processing circuitry 1020 and cache 1021), communication fabric 1011, volatile memory 1012, persistent storage 1013 (including operating system 1022, and the training system 306 as identified above), peripheral device set 1014 (including user interface (UI) device set 1023, storage 1024, and Internet of Things (IoT) sensor set 1025), and network module 1015. Remote server 1004 includes remote database 1030. Public cloud 1005 includes gateway 1040, cloud orchestration module 1041, host physical machine set 1042, virtual machine set 1043, and container set 1044.

COMPUTER 1001 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1030. As is well understood in the art of computer technology, and depending upon the technology, performance of a computer-implemented method may be distributed among multiple computers and/or between multiple locations. On the other hand, in this presentation of computing environment 1000, detailed discussion is focused on a single computer, specifically computer 1001, to keep the presentation as simple as possible. Computer 1001 may be located in a cloud, even though it is not shown in a cloud in FIG. 10. On the other hand, computer 1001 is not required to be in a cloud except to any extent as may be affirmatively indicated.

PROCESSOR SET 1010 includes one, or more, computer processors of any type now known or to be developed in the future. Processing circuitry 1020 may be distributed over multiple packages, for example, multiple, coordinated integrated circuit chips. Processing circuitry 1020 may implement multiple processor threads and/or multiple processor cores. Cache 1021 is memory that is located in the processor chip package(s) and is typically used for data or code that should be available for rapid access by the threads or cores running on processor set 1010. Cache memories are typically organized into multiple levels depending upon relative proximity to the processing circuitry. Alternatively, some, or all, of the cache for the processor set may be located “off chip.” The processor set 1010 may further include an artificial intelligence chip 1045 implementing the generative AI model 116 being trained by the training system 306. Alternatively, the generative AI model 116 may be implemented as software in the persistent storage 1013. In some computing environments, processor set 1010 may be designed for working with qubits and performing quantum computing.

Computer readable program instructions are typically loaded onto computer 1001 to cause a series of operational steps to be performed by processor set 1010 of computer 1001 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1021 and the other storage media discussed below. The program instructions, and associated data, are accessed by processor set 1010 to control and direct performance of the inventive methods. In computing environment 1000, at least some of the instructions for performing the inventive methods of the training system 306 and optimization problem solver 106 be stored in persistent storage 1013.

COMMUNICATION FABRIC 1011 is the signal conduction path that allows the various components of computer 1001 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 1012 is any type of volatile memory now known or to be developed in the future. Examples include dynamic type random access memory (RAM) or static type RAM. Typically, volatile memory 1012 is characterized by random access, but this is not required unless affirmatively indicated. In computer 1001, the volatile memory 1012 is located in a single package and is internal to computer 1001, but, alternatively or additionally, the volatile memory may be distributed over multiple packages and/or located externally with respect to computer 1001.

PERSISTENT STORAGE 1013 is any form of non-volatile storage for computers that is now known or to be developed in the future. The non-volatility of this storage means that the stored data is maintained regardless of whether power is being supplied to computer 1001 and/or directly to persistent storage 1013. Persistent storage 1013 may be a read only memory (ROM), but typically at least a portion of the persistent storage allows writing of data, deletion of data and re-writing of data. Some familiar forms of persistent storage include magnetic disks and solid state storage devices. Operating system 1022 may take several forms, such as various known proprietary operating systems or open source Portable Operating System Interface-type operating systems that employ a kernel. The code included in the persistent storage 1013, such as the training system 306, typically includes at least some of the computer code involved in performing the inventive methods.

PERIPHERAL DEVICE SET 1014 includes the set of peripheral devices of computer 1001. Data communication connections between the peripheral devices and the other components of computer 1001 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 1023 may include components such as a display screen, speaker, microphone, wearable devices (such as goggles and smart watches), keyboard, mouse, printer, touchpad, game controllers, and haptic devices. Storage 1024 is external storage, such as an external hard drive, or insertable storage, such as an SD card. Storage 1024 may be persistent and/or volatile. In some embodiments, storage 1024 may take the form of a quantum computing storage device for storing data in the form of qubits. In embodiments where computer 1001 is required to have a large amount of storage (for example, where computer 1001 locally stores and manages a large database) then this storage may be provided by peripheral storage devices designed for storing very large amounts of data, such as a storage area network (SAN) that is shared by multiple, geographically distributed computers. IoT sensor set 1025 is made up of sensors that can be used in Internet of Things applications. For example, one sensor may be a thermometer and another sensor may be a motion detector.

NETWORK MODULE 1015 is the collection of computer software, hardware, and firmware that allows computer 1001 to communicate with other computers through WAN 1002. Network module 1015 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1015 are performed on the same physical hardware device. In other embodiments (for example, embodiments that utilize software-defined networking (SDN)), the control functions and the forwarding functions of network module 1015 are performed on physically separate devices, such that the control functions manage several different network hardware devices. Computer readable program instructions for performing the inventive methods can typically be downloaded to computer 1001 from an external computer or external storage device through a network adapter card or network interface included in network module 1015.

WAN 1002 is any wide area network (for example, the internet) capable of communicating computer data over non-local distances by any technology for communicating computer data, now known or to be developed in the future. In some embodiments, the WAN 1002 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1003 is any computer system that is used and controlled by an end user (for example, a customer of an enterprise that operates computer 1001), and may take any of the forms discussed above in connection with computer 1001. EUD 1003 typically receives helpful and useful data from the operations of computer 1001. For example, in a hypothetical case where computer 1001 is designed to provide a recommendation to an end user, this recommendation would typically be communicated from network module 1015 of computer 1001 through WAN 1002 to EUD 1003. In this way, EUD 1003 can display, or otherwise present, the recommendation to an end user. In some embodiments, EUD 1003 may be a client device, such as thin client, heavy client, mainframe computer, desktop computer and so on. In certain embodiments, the EUD 1003 may include the data validation procedure to validate data sets at the EUD 1003. In certain embodiments, the EUD 1003 may implement the optimization problem solver 106, including the generative AI model, described above to solve optimization problems at the EUD 1003.

REMOTE SERVER 1004 is any computer system that serves at least some data and/or functionality to computer 1001. Remote server 1004 may be controlled and used by the same entity that operates computer 1001. Remote server 1004 represents the machine(s) that collect and store helpful and useful data for use by other computers, such as computer 1001. For example, in a hypothetical case where computer 1001 is designed and programmed to provide a recommendation based on historical data, then this historical data may be provided to computer 1001 from remote database 1030 of remote server 1004. In certain embodiments, the remote server 1004 may implement the optimization problem solver 106, including the generative AI model, as an inference engine to solve optimization problems for EUDs 1003 providing natural language descriptions of optimization problems to solve.

PUBLIC CLOUD 1005 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1005 is performed by the computer hardware and/or software of cloud orchestration module 1041. The computing resources provided by public cloud 1005 are typically implemented by virtual computing environments that run on various computers making up the computers of host physical machine set 1042, which is the universe of physical computers in and/or available to public cloud 1005. The virtual computing environments (VCEs) typically take the form of virtual machines from virtual machine set 1043 and/or containers from container set 1044. It is understood that these VCEs may be stored as images and may be transferred among and between the various physical machine hosts, either as images or after instantiation of the VCE. Cloud orchestration module 1041 manages the transfer and storage of images, deploys new instantiations of VCEs and manages active instantiations of VCE deployments. Gateway 1040 is the collection of computer software, hardware, and firmware that allows public cloud 1005 to communicate through WAN 1002.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1006 is similar to public cloud 1005, except that the computing resources are only available for use by a single enterprise. While private cloud 1006 is depicted as being in communication with WAN 1002, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1005 and private cloud 1006 are both part of a larger hybrid cloud.

Cloud computing services and/or microservices (not separately shown in FIG. 10): private and public clouds are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, and laptops), through the Internet, to the provider's systems, and back. In some embodiments, cloud services can be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs (Application Programming Interfaces). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on-demand, and virtual private networks. In certain embodiments, the cloud computing services may include the optimization problem solver 106 to provide optimization problem solving services.

The letter designators, such as i and j are used herein to designate a number of instances of an element may indicate a variable number of instances of that element when used with the same or different elements.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

What is claimed is:

1. A computer implemented method to optimize an optimization problem, comprising:
processing a natural language description of an optimization problem to generate extracted components comprising decision variables and constraints of the optimization problem;
processing the extracted components of the decision variables and the constraints to generate a mathematical formulation of the decision variables and the constraints;
processing the mathematical formulation to generate optimization models implementing the mathematical formulation in different optimization modelling languages;
processing, by an optimization solver, the optimization models to generate optimal solutions to the optimization problem; and
determining an optimal solution to the optimization problem from the optimal solutions.

2. The computer implemented method of claim 1, wherein the determining the optimal solution comprises:
determining whether a majority of the optimization models result in a same optimal solution, wherein the optimal solution comprises the same optimal solution from the majority of optimization models.

3. The computer implemented method of claim 1, wherein the processing the mathematical formulation to generate the optimization models comprises processing the natural language description of the optimization problem and the mathematical formulation to generate the optimization models in different optimization modelling languages.

4. The computer implemented method of claim 1, further comprising:
sending a first prompt requesting a generative artificial intelligence (AI) model to generate the extracted components from the natural language description of the optimization problem;
sending a second prompt requesting the generative AI model to generate the mathematical formulation from the extracted components; and
sending a third prompt requesting the generative AI model to generate the optimization models in the different optimization modelling languages.

5. The computer implemented method of claim 1, further comprising:
processing the natural language description to determine assumptions and hypotheses defined in the natural language description; and
determining whether the constraints in the extracted components satisfy the assumptions and hypotheses, wherein the extracted components are processed to generate the mathematical formulation in response to determining that the constraints in the extracted components satisfy the assumptions and hypotheses.

6. The computer implemented method of claim 1, further comprising:
processing the natural language description and the extracted components to determine assumptions and hypotheses based on the natural language description and the extracted components; and
determining whether conclusions from the mathematical formulation satisfy the assumptions and hypotheses, wherein the processing the mathematical formulation to generate the optimization models is performed in response to determining that the conclusions of the mathematical formulation satisfy the assumptions and hypotheses.

7. The computer implemented method of claim 1, further comprising:
processing the natural language description and the extracted components to validate the extracted components as providing conclusions that satisfy the optimization problem, wherein the processing the extracted components to generate the mathematical formulation is performed in response to validating the extracted components; and
processing the natural language description, the extracted components, and the mathematical formulation to validate the mathematical formulation as providing conclusions that satisfy the optimization problem, wherein the processing the mathematical formulation to generate the optimization models is performed in response to determining that the conclusions of the mathematical formulation satisfy the optimization problem.

8. The computer implemented method of claim 1, wherein a generative artificial intelligence (AI) model performs the processing the natural language description of the optimization problem to generate the extracted components, the processing the extracted components to generate the mathematical formulation, and the processing the mathematical formulation to generate the optimization models.

9. The computer implemented method of claim 8, further comprising:
determining that the optimization solver when processing an optimization model generated an error indicating the optimization solver was unable to generate output for an optimal solution, wherein the processing the optimization models to generate the optimal solutions is performed in response to no optimization model resulting in an error when processed by the optimization solver; and
forwarding the error to the generative AI model to regenerate an optimization model that when executed by the optimization solver results in output for an optimal solution.

10. A computer system comprising:
a processor set;
one or more computer-readable storage media; and
program instructions stored on the one or more computer-readable storage media to cause the processor set to perform operations comprising:
processing a natural language description of an optimization problem to generate extracted components comprising decision variables and constraints of the optimization problem;
processing the extracted components of the decision variables and the constraints to generate a mathematical formulation of the decision variables and the constraints;
processing the mathematical formulation to generate optimization models implementing the mathematical formulation in different optimization modelling languages;
processing, by an optimization solver, the optimization models to generate optimal solutions to the optimization problem; and
determining an optimal solution to the optimization problem from the optimal solutions.

11. The system of claim 10, wherein the determining the optimal solution comprises:
determining whether a majority of the optimization models result in a same optimal solution, wherein the optimal solution comprises the same optimal solution from the majority of optimization models.

12. The system of claim 10, wherein the operations further comprise:
sending a first prompt requesting a generative artificial intelligence (AI) model to generate the extracted components from the natural language description of the optimization problem;
sending a second prompt requesting the generative AI model to generate the mathematical formulation from the extracted components; and
sending a third prompt requesting the generative AI model to generate the optimization models in the different optimization modelling languages.

13. The system of claim 10, wherein the operations further comprise:
processing the natural language description and the extracted components to determine assumptions and hypotheses based on the natural language description and the extracted components; and
determining whether conclusions from the mathematical formulation satisfy the assumptions and hypotheses, wherein the processing the mathematical formulation to generate the optimization models is performed in response to determining that the conclusions of the mathematical formulation satisfy the assumptions and hypotheses.

14. The system of claim 10, wherein the operations further comprise:
processing the natural language description and the extracted components to validate the extracted components as providing conclusions that satisfy the optimization problem, wherein the processing the extracted components to generate the mathematical formulation is performed in response to validating the extracted components; and
processing the natural language description, the extracted components, and the mathematical formulation to validate the mathematical formulation as providing conclusions that satisfy the optimization problem, wherein the processing the mathematical formulation to generate the optimization models is performed in response to determining that the conclusions of the mathematical formulation satisfy the optimization problem.

15. The system of claim 10, further comprising:
a generative artificial intelligence (AI) model to perform the processing the natural language description of the optimization problem to generate the extracted components, the processing the extracted components to generate the mathematical formulation, and the processing the mathematical formulation to generate the optimization models.

16. A computer program product comprising:
one or more computer-readable storage media; and
program instructions stored on the one or more computer-readable storage media to perform operations comprising:
processing a natural language description of an optimization problem to generate extracted components comprising decision variables and constraints of the optimization problem;
processing the extracted components of the decision variables and the constraints to generate a mathematical formulation of the decision variables and the constraints;
processing the mathematical formulation to generate optimization models implementing the mathematical formulation in different optimization modelling languages;
processing, by an optimization solver, the optimization models to generate optimal solutions to the optimization problem; and
determining an optimal solution to the optimization problem from the optimal solutions.

17. The computer program product of claim 16, wherein the determining the optimal solution comprises:
determining whether a majority of the optimization models result in a same optimal solution, wherein the optimal solution comprises the same optimal solution from the majority of optimization models.

18. The computer program product of claim 16, wherein the operations further comprise:
sending a first prompt requesting a generative artificial intelligence (AI) model to generate the extracted components from the natural language description of the optimization problem;
sending a second prompt requesting the generative AI model to generate the mathematical formulation from the extracted components; and
sending a third prompt requesting the generative AI model to generate the optimization models in the different optimization modelling languages.

19. The computer program product of claim 16, wherein the operations further comprise:
processing the natural language description and the extracted components to determine assumptions and hypotheses based on the natural language description and the extracted components; and
determining whether conclusions from the mathematical formulation satisfy the assumptions and hypotheses, wherein the processing the mathematical formulation to generate the optimization models is performed in response to determining that the conclusions of the mathematical formulation satisfy the assumptions and hypotheses.

20. The computer program product of claim 16, further comprising:
a generative artificial intelligence (AI) model to perform the processing the natural language description of the optimization problem to generate the extracted components, the processing the extracted components to generate the mathematical formulation, and the processing the mathematical formulation to generate the optimization models.
